(19) United States
(12) Patent Application Publication
(10) Pub. No.: US 2014/0104599 A1
(43) Pub. Date: Apr. 17, 2014

(54) METHOD OF IMPROVING PERFORMANCE OF OPTICAL TIME DOMAIN REFLECTOMETER (OTDR)

(71) Applicant: Electronics and Telecommunications Research Institute, Daejeon-si (KR)

(72) Inventors: Won-Kyoung LEE, Daejeon-si (KR); Jyung-Chan LEE, Daejeon-si (KR); Seung-Il MYONG, Daejeon-si (KR)

(73) Assignee: Electronics and Telecommunications Research Institute, Daejeon-si (KR)

(21) Appl. No.: 14/049,595

(22) Filed: Oct. 9, 2013

(30) Foreign Application Priority Data
Oct. 12, 2012 (KR) 10-2012-0113697

(51) Int. Cl. G01M 11/00

(52) U.S. Cl. CPC G01M 11/3145
USPC 356/73.1

(57) ABSTRACT

A method of improving the performance of an optical time domain reflectometer (OTDR) is provided. The method according to an embodiment of the present invention can increase accuracy of a distance of the OTDR through an initial calibration method with respect to the refractive index of an optical fiber, and can accurately detect a fault position and accurately analyze a fault cause through a real-time calibration method with respect to the refractive index of the optical fiber when faults and performance degradation occur.

### CROSS-REFERENCE TO RELATED APPLICATION(S)

This application claims priority from and the benefit under 35 U.S.C. §119(a) of Korean Patent Application No. 10-2012-0113697 filed on Oct. 12, 2012 in the Korean Intellectual Property Office (KIPO), the entire contents of which are hereby incorporated by reference.

### BACKGROUND

1. Technical Field

Example embodiments of the present invention relate to technologies for improving the performance of an optical time domain reflectometer (OTDR) that is used to monitor faults in an optical component and an optical fiber used as a transmission medium, and to find a point where a fault occurs.

2. Related Art

An optical time domain reflectometer (hereinafter, referred to as an “OTDR”), which is one type of optical link defect monitoring device is a device for measuring a loss or attenuation characteristics of an optical fiber using backscattered signals and back-reflected signals when injecting a short pulse into the optical fiber.

When an optical signal is input to one cross-section of the optical fiber, propagation of the optical signal is guided by total internal reflection without great loss. However, when a significant change occurs in a refractive index due to a splicing point between a connector and an optical fiber, bending, cutting, or the like, Rayleigh scattering and Fresnel reflection phenomena occur. In this instance, OTDR may measure optical signals returning back to an input port by Rayleigh scattering and Fresnel reflection so as to monitor a status of the optical fiber such as bending, cutting, or the like.

The performance of OTDR that monitors the status of the optical fiber is determined by the following parameters. The parameters may include a dynamic range, a measurement range, an event dead zone (EDZ), a loss-measurement dead zone (LMDZ), a total return loss, linearity, data resolution, clock accuracy, error in a refractive index, and the like.

The accuracy of OTDR is influenced by several factors. The accuracy of OTDR may be reduced by non-linearity due to a thermal effect, error in clock sampling interval, error in the refractive index of an optical fiber, and the like. Error in the refractive index of the optical fiber may exert a larger influence on accuracy of a distance than non-linearity and error in clock sampling interval.

An OTDR trace is obtained by converting reflected signal intensity measured as a function of time into a function of distance. Until now, as the refractive index of an optical fiber used when converting the function of time into the function of distance, a specific value in an initial operation of setting conditions of OTDR has been used. There may be a small difference between the refractive index of the optical fiber configured in the initial operation and the refractive index of an optical fiber actually laid.

In addition, the refractive index of a specific part of an optical fiber may be changed due to external pressure, bending, sudden temperature change, or the like.

Therefore, current OTDR technology that converts the OTDR trace from a function of time into a function of distance by fixing the refractive index of the optical fiber as a value of an OTDR initial setting operation has low accuracy.

In addition, existing technologies for improving the accuracy of OTDR generally aim to reduce error in clock sampling interval.

### SUMMARY

Accordingly, example embodiments of the present invention are provided to substantially obviate one or more problems due to limitations and disadvantages of the related art.

Example embodiments of the present invention provide a method of calibrating an optical time domain reflectometer (OTDR) that can accurately detect a position where a fault and performance degradation occur, and accurately analyze causes of the fault and performance degradation, by reducing error in the refractive index of an optical fiber to increase accuracy of a distance on an OTDR trace.

In some example embodiments, a method of improving the performance of an optical time domain reflectometer (OTDR) includes: measuring a time when Fresnel reflection occurs in an optical fiber, using the OTDR; calculating a total length of the optical fiber using the measured time when Fresnel reflection occurs and an initial value of the refractive index of the optical fiber; and comparing the calculated total length of the optical fiber and a physically measured total length of the optical fiber, calibrating the refractive index of the optical fiber so as to match the calculated total length with the physically measured total length when the calculated total length and the physically measured total length do not match, and setting the calibrated refractive index of the optical fiber as the initial value of the refractive index.

Here, the measuring of the time when Fresnel reflection occurs may include measuring the time when Fresnel reflection occurs in a connector part of an end of the optical fiber as a part where a change in an external shape of the optical fiber is generated.

Also, the setting of the calibrated refractive index may include acquiring a calibration value of the refractive index of the optical fiber using the time when Fresnel reflection occurs and the physically measured total length of the optical fiber.

Also, the method may further include acquiring an OTDR trace by converting reflected signal intensity measured as a function of time through the OTDR into a function of distance using the set initial value of the refractive index.

In other example embodiments, a method of improving the performance of an OTDR includes: measuring a time when Fresnel reflection occurs in an optical fiber, using the OTDR; calculating a total length of the optical fiber using the measured time when Fresnel reflection occurs and an initial value of the refractive index of the optical fiber; calculating an amount of change in the refractive index of the optical fiber with respect to a distance from the calculated total length of the optical fiber; and comparing the calculated amount of change in the refractive index and a threshold value to determine a type of a fault in the optical fiber based on the comparison result.

Here, the calculating of the amount of change in the refractive index may include calculating the amount of change in the refractive index using a difference value between a physically measured total length of the optical fiber and the calculated total length of the optical fiber, and the measured time when Fresnel reflection occurs.

Also, the comparing of the calculated amount of change in the refractive index may include comparing the calculated amount of change in the refractive index and the threshold value, and ascertaining whether a there is a peak in an OTDR trace between both ends of the optical fiber when the calculated amount of change is larger than the threshold value, and determining the type of fault in the optical fiber to be a fault due to cutting of the optical fiber when there is a peak, and to be a fault due to a splicing point or bending of the optical fiber when there is no peak.

Also, the ascertaining of whether there is a peak may include measuring intensity of a backscattered signal of two wavelengths when there is no peak, determining the type of fault in the optical fiber as a fault due to a splicing point of the optical fiber when the intensity of the backscattered signal of shorter wavelength, is larger than the intensity of the backscattered signal of longer wavelength, and determining the type of fault in the optical fiber as a fault due to the bending of the optical fiber when the intensity of the backscattered signal with respect to the monitoring signal of shorter wavelength is smaller than the intensity of the backscattered signal with respect to the monitoring signal of longer wavelength.

Also, the monitoring signals of two wavelengths may be signals with different wavelengths from each other generated by different light sources.

Also, the monitoring signals of two wavelengths may include a signal generated from a predetermined light source and having a first wavelength, and a signal having a second wavelength generated by shifting the first wavelength of the signal generated from the predetermined light source.

Also, the method may further include returning the refractive index of the optical fiber to an initially set refractive index; and performing fault recovery in accordance with fault alarm and fault type.

Also, the method may further include compiling the calculated amount of change in the refractive index of the optical fiber into a database to use the amount of change in the refractive index as statistical information.

In still other example embodiments, a method of improving the performance of an OTDR includes: measuring a time when Fresnel reflection occurs at a point where a connector is connected between each of a plurality of optical fiber sections through the OTDR; calculating a length of an optical fiber for each of the plurality of optical fiber sections using the measured time when Fresnel reflection occurs and an initial value of the refractive index of the optical fiber; and comparing the calculated length of the optical fiber for each of the plurality of optical fiber sections and a physically measured length of the optical fiber for each of the plurality of optical fiber sections, calibrating the refractive index of the optical fiber for each of the plurality of optical fiber sections so as to match the calculated length of the optical fiber and the physically measured length of the optical fiber when the calculated length of the optical fiber and the physically measured length of the optical fiber do not match, and setting the calibrated refractive index of the optical fiber as the initial value of the refractive index of the optical fiber for each of the plurality of optical fiber sections.

Here, the setting of the calibrated refractive index as the initial value of the refractive index may include acquiring a calibration value of the refractive index of the optical fiber for each of the plurality of optical fiber sections, using the time when Fresnel reflection occurs for each of the plurality of optical fiber sections and the physically measured length of the optical fiber for each of the plurality of optical fiber sections.

Also, the method may further include acquiring an OTDR trace by converting reflected signal intensity measured as a function of time into a function of distance using the set initial value of the refractive index for each of the plurality of optical fiber sections.

### BRIEF DESCRIPTION OF DRAWINGS

Example embodiments of the present invention will become more apparent by describing in detail example embodiments of the present invention with reference to the accompanying drawings, in which:

FIG. 1 is a configuration diagram showing a basic structure of an optical link defect monitoring device according to an embodiment of the present invention;

FIG. 2 is a graph showing a trace of general optical time domain reflectometer (OTDR) signals;

FIG. 3 is a graph for explaining a reflective dynamic range;

FIG. 4 is a graph for explaining a scattering dynamic range;

FIG. 5 is a graph showing an influence of offset of an optical component on linearity of an OTDR trace;

FIG. 6 is a graph for explaining an event dead zone;

FIG. 7 is a graph for explaining a loss-measurement dead zone;

FIG. 8 is a flowchart showing an OTDR initial calibration method according to an embodiment of the present invention;

FIGS. 9A and 9B are flowcharts showing an OTDR real-time calibration method according to an embodiment of the present invention;

FIG. 10 is a diagram showing an OTDR trace when several optical fibers with different refractive indexes are connected; and

FIG. 11 is a flowchart showing a calibration method of the refractive index of an OTDR when several optical fibers with different refractive indexes are connected according to an embodiment of the present invention.

### DETAILED DESCRIPTION

Example embodiments of the present invention are disclosed below in sufficient structural and functional detail to enable those of ordinary skill in the art to embody the present invention. However, the present invention may be embodied in many alternate forms and should not be construed as limited to the example embodiments set forth herein.

With reference to the appended drawings, exemplary embodiments of the present invention will be described in detail below. Elements that appear in more than one drawing or are mentioned in more than one place in the description are always denoted by the same respective reference numerals, and each element will only be described once.

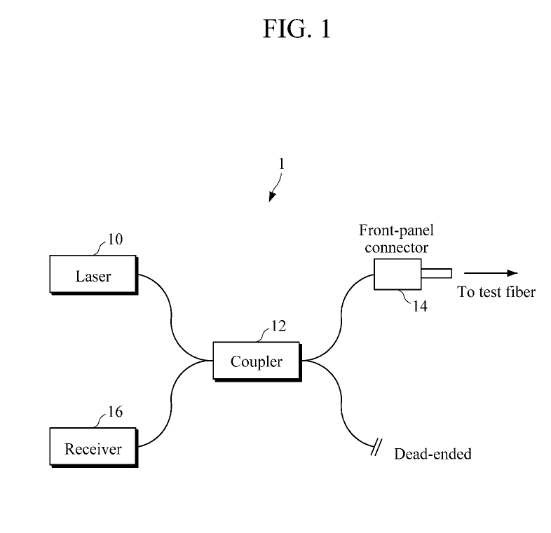

FIG. 1 is a configuration diagram showing a basic structure of an optical link defect monitoring device 1 according to an embodiment of the present invention.

The optical link defect monitoring device 1 is a device for monitoring a state of an optical link, and includes, for example, an optical time domain reflectometer (OTDR). Hereinafter, the optical link defect monitoring device 1 shall be limited to an OTDR and may be alternatively referred to as an OTDR 1.

Referring to FIG. 1, a laser 10 of the OTDR 1 is connected to a coupler 12. An optical signal output from the laser 10 is applied to a test fiber through the coupler 12 and a front-panel connector 14. The optical signal applied to an optical fiber is reflected or scattered in the optical fiber and received at a receiver 16 again through the coupler 12.

The intensity of the optical signal applied to the optical fiber is reduced due to absorption and Rayleigh scattering while passing through the optical fiber.

In addition, at a point where the refractive index of the optical fiber is rapidly changed or cut off, Fresnel reflection occurs in a direction opposite to an incident direction, and therefore the intensity of the optical signal is reduced.

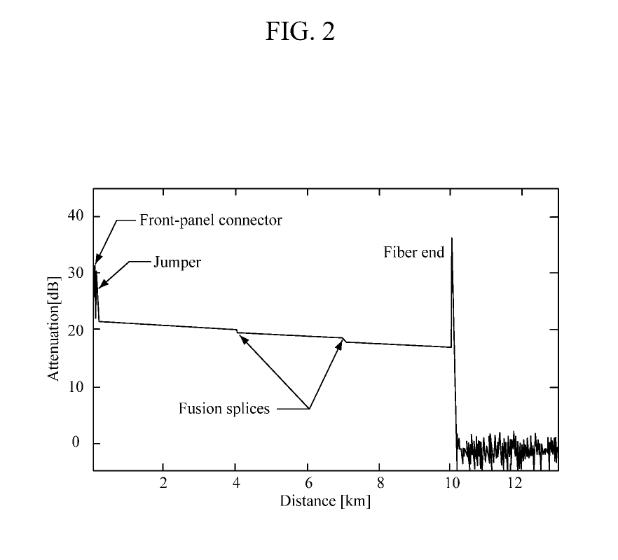

FIG. 2 is a graph showing a trace of general OTDR signals.

In the present specification, an OTDR trace may be obtained by an arbitrary method of storing or displaying processed data by OTDR signal acquisition, and the data may be proportional to a measured optical signal as a time delay function.

In such time delay, a function of time may be converted into a function of distance by applying a known relationship using a known or assumed refractive index of the optical fiber at each OTDR wavelength.

Referring to FIG. 2, Fresnel reflection occurs due to a sudden change in the refractive index at an end of the test optical fiber, a front-panel connector, or a connector of a jumper, and therefore a sharp peak appears in the OTDR trace. At a point where splicing or bending of the optical fiber occurs, only Rayleigh scattering may occur.

Accordingly, there is no sharp peak at a position where splicing or bending of the optical fiber occurs, and the intensity of the optical signal is reduced by Rayleigh backscattering in a linear section.

In FIG. 2, the vertical axis indicates intensity in decibels [dB] of a returning optical signal due to Rayleigh backscattering and Fresnel reflection, and the horizontal axis indicates distance in meters [m].

However, a receiver measures the intensity of linear optical signals as a function of time, in milliwatts [mW]. Thus, in order to draw the OTDR trace, internal processing for converting time into distance and mW into dB is required.

An equation for converting time (t) into distance (d) is the following Equation 1.

$$d [ m ] = \frac{t [ s ]}{2} \times {v}_{g} [ m / s ] \qquad ( 1 )$$

Referring to Equation 1, since a measured time (t) is a time during which an optical signal returns, a distance is travelled twice, and therefore, in order to obtain a distance (d), the time (t) is must be divided by 2, and then multiplied by a speed (vg) at which the optical signal travels through the optical fiber.

An equation for converting the intensity (P) of the returned optical signal into decibels [dB] is the following Equation 2.

$$P [ dB ] = 5 log ( \frac{{p}_{0} [ mW ]}{{p}_{1} [ mW ]} ) \qquad ( 2 )$$

In Equation 2, P₀ indicates intensity of Rayleigh backscattering before an event is generated, and P₁ indicates intensity of Rayleigh backscattering after an event is generated. The reason for multiplying by 5 instead of 10 in the equation for converting the intensity (P) of the optical signal into decibels [dB] is because the optical signal is attenuated a second time over the return trip.

Meanwhile, performance of the OTDR that monitors a state of the optical fiber is determined by parameters including a dynamic range, a measurement range, an event dead zone (EDZ), a loss-measurement dead zone (LMDZ), a total return loss, linearity, data resolution, clock accuracy, error in a refractive index, and the like.

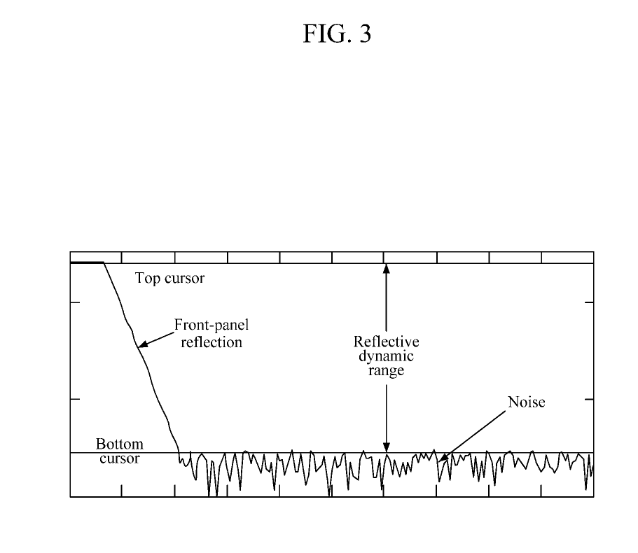

Hereinafter, the parameters that determine performance of the OTDR will be described with reference to FIGS. 3 to 7.

FIG. 3 is a graph for explaining a reflective dynamic range.

Referring to FIG. 3, a dynamic range is a parameter indicating a difference from a maximum value of a signal that can be measured by the OTDR and a noise floor. The dynamic range denotes receiver's sensitivity of the OTDR and is a very important parameter because the dynamic range is an indicator of the maximum distance that can be allowed by measured by the OTDR.

The dynamic range may be subdivided into a reflective dynamic range and a scattering dynamic range.

The reflective dynamic range denotes a difference between an optical signal reflected by a front-panel connector of the OTDR and system noise of the OTDR, as shown in FIG. 3, and is an important parameter for determining receiver's sensitivity that can be measured by the OTDR. The reflective dynamic range is defined the difference in optical intensity between the highest point of reflection and the noise floor in a state in which an optical fiber to be tested is not connected.

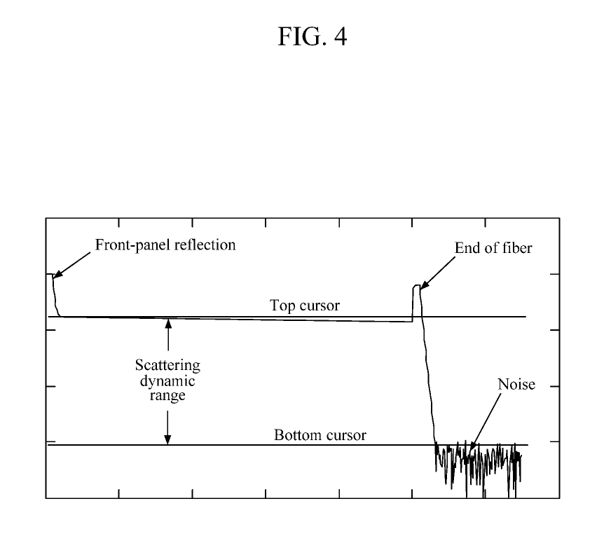

FIG. 4 is a graph for explaining a scattering dynamic range.

Referring to FIG. 4, the scattering dynamic range is a difference in optical intensity between a backscattered level of a front-panel connector and a noise floor.

A level of the noise floor may dynamically change in accordance with offset values of optical components such as an analog-to-digital converter (ADC). When the level of the noise floor changes in accordance with the offset value of the optical component, the change in the level of the noise floor may affect the dynamic range. Accordingly, in order to measure the dynamic range in a state in which such an offset effect of the optical components is excluded, an end of linearity of the OTDR trace may be determined as the level of the noise floor.

In addition, when using an average value obtained by performing measurement several times, variation of the noise floor may be reduced to improve the dynamic range.

The level of the noise floor may be defined as RSM or SNR=1. However, in reality, it is not easy to measure RSM or SNR=1. As more realistic definition, a noise level of 98% or an end of linearity may be used.

In terms of monitoring a state of an optical fiber, the dynamic range of the OTDR may refer to the scattering dynamic range.

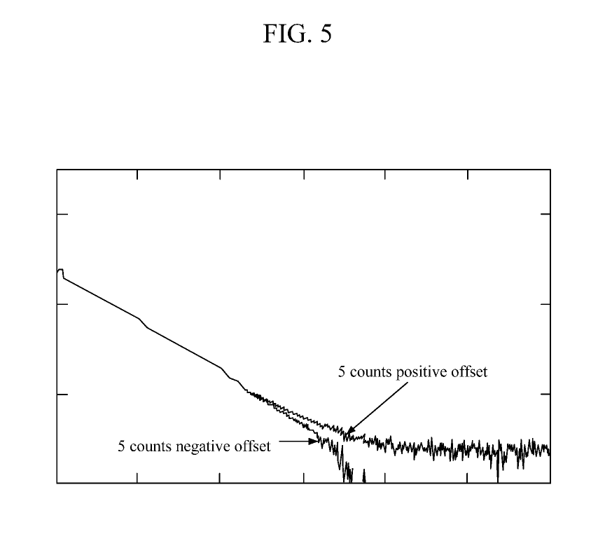

FIG. 5 is a graph showing an influence of offset of an optical component on linearity of an OTDR trace.

A measurement range, which is one of the parameters for determining performance of the OTDR, denotes a maximum distance at which an event can be detected and measured with predetermined accuracy. The dynamic range is a hardware parameter associated with performance, whereas the measurement range is a system parameter for estimating complex performance of hardware and event marking software, which is more practical.

According to an embodiment, the measurement range refers to a maximum distance at which three non-reflective events can be collected for four non-reflective events with a loss of 0.5 dB. The OTDR represents a trace in a linear manner, and represents a y-axis of the OTDR trace logarithmically in order to view even a small event.

However, as shown in FIG. 5, an offset voltage of an OTDR signal acquisition circuit is added to an optical signal, so that the OTDR trace may nonlinearly change. Nonlinearity of the OTDR trace due to such an offset voltage may cause error in estimating the dynamic range and may reduce the measurement range.

linear trace: 5 log(exp(−αx))

nonlinear trace: 5 log(exp(−αx)+α).

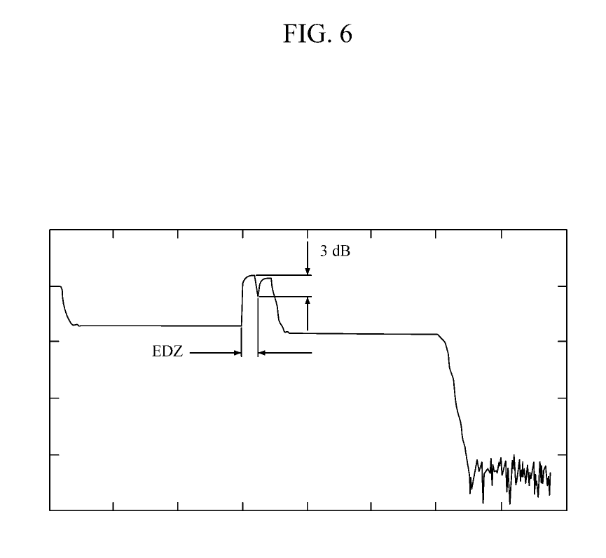

FIG. 6 is a graph for explaining an event dead zone.

Referring to FIG. 6, an event dead zone (EDZ) is the ability to identify two reflective events divided by a short distance.

A distance to a position 3 dB away from a leading edge of a first event may be an EDZ.

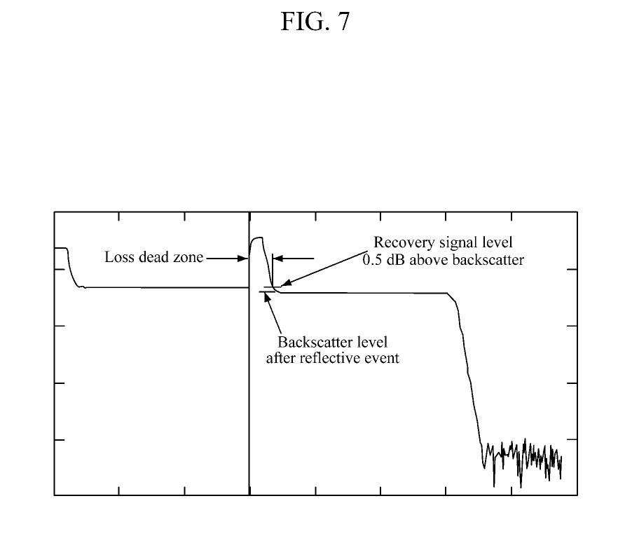

FIG. 7 is a graph for explaining a loss-measurement dead zone (LMDZ).

Referring to FIG. 7, an LMDZ indicates the ability to measure a large reflective event without distortion of a trace, and is defined as a distance from a position where reflection starts to a position where recovery is performed to within 0.5 dB of a normal scattered level.

Meanwhile, a total return loss may signify a sum of reflected optical intensities with respect to all events, and accuracy of the total return loss should be within 2 dB for the purpose of system reliability.

Linearity, meaning linearity of an OTDR trace, indicates the ability to ascertain whether loss per length of an optical fiber is constant and is one of the parameters for determining accuracy of performance of OTDR.

Nonlinearity of the OTDR trace is generally generated by an offset error due to a thermal effect of an optical component.

Data resolution is also one of the parameters for determining the performance of OTDR.

Data of the OTDR trace is acquired by sampling at regular intervals in a time domain. The interval between the sampled data is converted from units of time into units of distance, and a sampling interval converted into units of distance is called data density.

As a method of reducing the sampling interval, an interleaving method may be used.

In the interleaving method, the sampling interval may be reduced by acquiring data in such a manner that time delay occurs before a sampler is triggered.

Clock accuracy is also one of the parameters indicating accuracy of OTDR.

Analysis with respect to OTDR monitoring signals in a time domain uses a clock.

Error in the clock affects uncertainty of distance measurement.

Error in the refractive index of an optical fiber is also one of the parameters indicating accuracy of OTDR. The refractive index of the optical fiber is a value obtained by dividing the speed of light in a vacuum by the speed of a pulse propagating through a core of an optical fiber.

Error in the refractive index of the optical fiber significantly deteriorates accuracy of distance measurement of OTDR.

In general, error in the refractive index of the optical fiber is about 0.1% (0.001/1.456=0.00069). When a total length of the optical fiber is assumed to be 50 km, error in distance measurement due to error in the refractive index of the optical fiber is 0.00069×50,000 m=34 m.

The error in distance measurement due to error in the refractive index of the optical fiber in actual OTDR measurement may be at least 10 times larger than error in distance measurement due to an error of a clock or a sampling interval.

In the present invention, in order to accurately locate a point where a link fault occurs, a method of minimizing error in the refractive index of the optical fiber is proposed.

Error in the refractive index of the optical fiber has the following two main causes.

The first cause is error that occurs in an initial setting operation of the refractive index of the optical fiber in a process of converting OTDR data measured as a function of time into a function of distance. That is, the first cause corresponds to a case in which information about the refractive index of the optical fiber to be measured is inaccurate.

The second cause corresponds to a case in which the refractive index of the optical fiber changes due to environmental factors over time such as external pressure, bending, temperature, and the like.

According to an embodiment of the present invention, the first cause may be solved through a process of calibrating initial setting before starting an OTDR, and the second cause may be solved through a real-time calibration process while measuring the OTDR in real-time, a process of detecting faults and performance reduction, and a process of analyzing a fault cause.

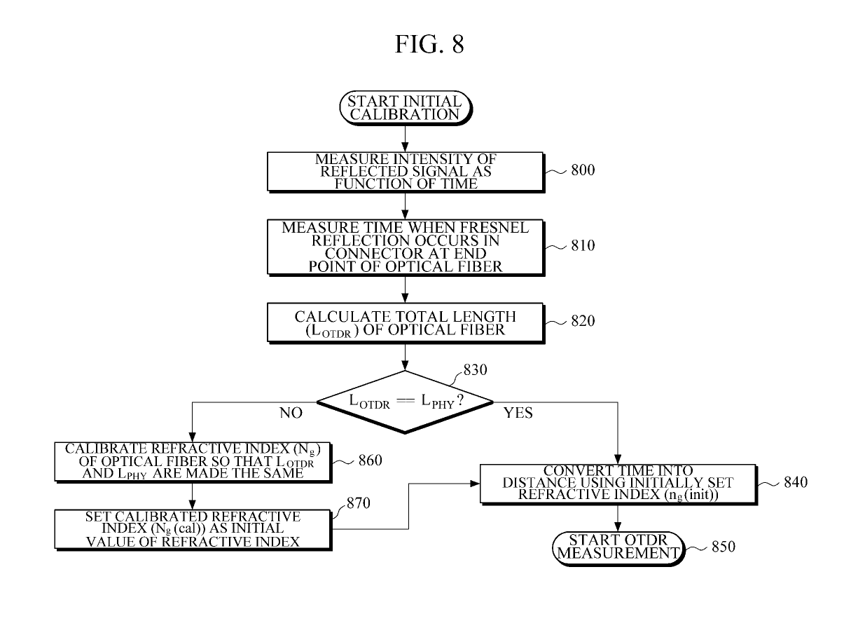

Hereinafter, a calibration method according to various embodiments of the present invention will be described with reference to FIGS. 8 to 11.

FIG. 8 is a flowchart showing an OTDR initial calibration method according to an embodiment of the present invention.

Referring to FIG. 8, an initial calibration method of the present invention is a method of improving distance resolution of an OTDR in a state in which an optical fiber cable is buried in the ground, or a normal state in which a fault does not occur in the optical fiber cable already buried in the ground.

An apparatus for improving the performance of an OTDR according to the present invention may calibrate the refractive index of an optical fiber so that a physically measured length of the optical fiber is the same as a length of the optical fiber measured by the OTDR.

For this, in operation 800, the apparatus for improving the performance of the OTDR measures the intensity of reflected signals using a function of time through the OTDR.

Next, in operation 810, the apparatus measures a time (T_{FR}) when Fresnel reflection occurs in a connector of an end of an optical fiber.

In operation 820, the apparatus calculates a total length (L_{OTDR}) of the optical fiber using Equation 3.

$${L}_{OTDR} = \frac{c}{{n}_{g} ( init )} \times {T}_{FR} \qquad ( 3 )$$

In Equation 3, c=299,792,458 m/s (about 3×10⁸ m/s) is the speed of light in a vacuum, and n_{g}(init) denotes the refractive index of an optical fiber that is initially set to convert a function of time into a function of distance in an OTDR.

Next, in operation 830, the apparatus compares the total length (L_{OTDR}) of the optical fiber measured through the OTDR and an actual length (L_{PHY}) of the optical fiber that is physically measured.

In operation 840, when the two lengths are the same (L_{OTDR}=L_{PHY}), the apparatus converts the function of time into the function of distance using the initially set refractive index (Δn_{g}(init)) of the optical fiber as is, without additionally calibrating the initially set refractive index (Δn_{g}(init)) of the optical fiber.

In operation 850, the apparatus starts measurement of an OTDR trace.

However, in operation 860, when the two lengths are different (L_{OTDR}≠L_{PHY}), the apparatus calibrates the initially set refractive index of the optical fiber using Equation 4 so that the two lengths are made the same.

$${n}_{g} ( cal ) = \frac{c}{{L}_{PHY}} \times {T}_{FR} \qquad ( 4 )$$

Next, in operations 840 and 850, the apparatus starts measurement of the OTDR trace after setting the calibrated refractive index (n_{g}(cal)) as the initial refractive index (Δn_{g}(init)) of the OTDR (Δn_{g}(init)=n_{g}(cal)) in operation 870.

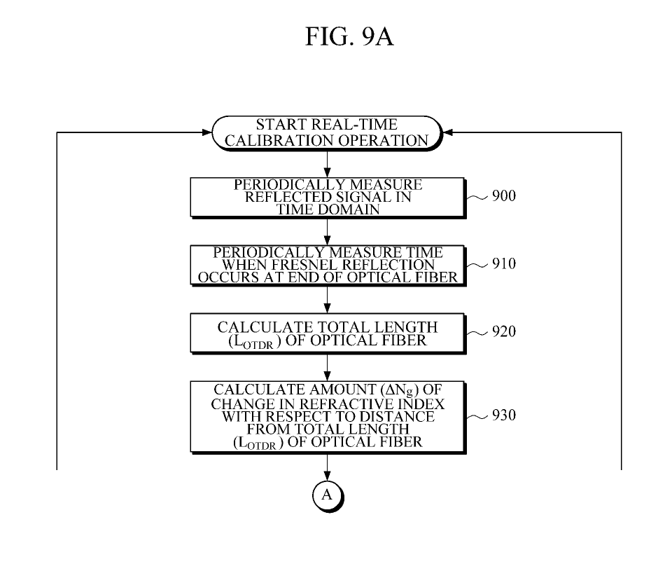

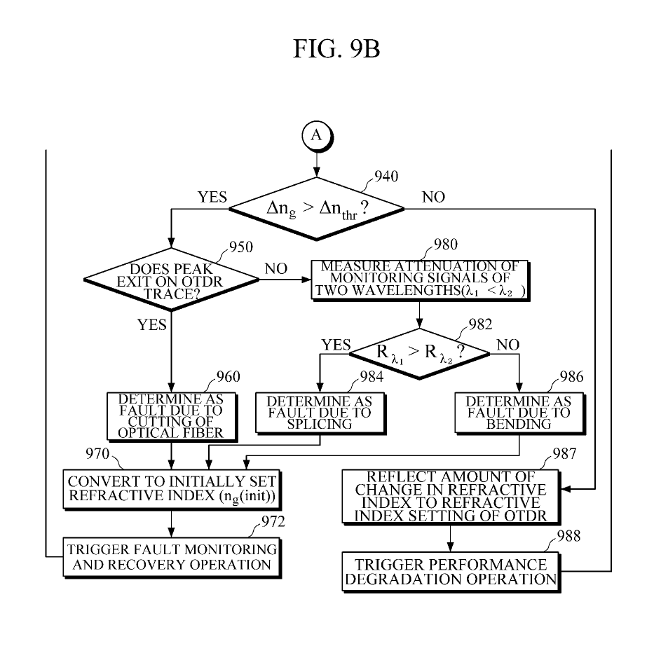

FIGS. 9A and 9B are flowcharts showing an OTDR real-time calibration method according to an embodiment of the present invention.

Referring to FIGS. 9A and 9B, the OTDR real-time calibration method according to an embodiment of the present invention is a method of improving distance resolution of an OTDR by monitoring for faults and performance degradation due to cutting, splicing, bending, or the like, of the optical fiber, in real-time.

For this, an apparatus for improving the performance of an OTDR according to an embodiment of the present invention periodically monitors changes in a reflective index of an optical fiber to determine performance degradation and faults in the optical fiber.

In addition, the apparatus diagnoses causes of a fault or performance degradation.

First, in operation 900, the apparatus periodically measures reflected signals in a time domain through an OTDR.

In operation 910, the apparatus periodically measures a time (T_{FR}) when Fresnel reflection occurs in a connector of an end of an optical fiber.

Next, in operation 920, the apparatus calculates a total length (L_{OTDR}) of the optical fiber through Equation 5 using the time (T_{FR}) when Fresnel reflection occurs and the refractive index calibrated by the initial calibration method that has been described with reference to FIG. 8.

$${L}_{OTDR} = \frac{c}{{n}_{g} ( init )} \times {T}_{FR} \qquad ( 5 )$$

Next, in operation 930, the apparatus calculates an amount (Δn_{g}) of change in the refractive index of the optical fiber from the total length of the optical fiber that has been measured through the OTDR, using Equation 6.

$$Δ {n}_{g} = \frac{c}{\vert {L}_{PHY} - {L}_{OTDR} \vert} \times {T}_{FR} \qquad ( 6 )$$

Next, in operation 940, the OTDR compares the amount (Δn_{g}) of change in the refractive index of the optical fiber and a threshold value (Δnₜₕᵣ) of an amount of change in the refractive index for distinguishing between a fault and performance degradation.

When the amount (Δn_{g}) of change in the refractive index exceeds the threshold value (Δnₜₕᵣ), the problem is determined to be a fault in the optical fiber, so that the apparatus determines there to be a fault and measure an accurate position of the fault.

When the amount (Δn_{g}) of change in the refractive index does not exceed the threshold value (Δnₜₕᵣ), the problem is determined to be performance degradation rather than a fault.

a) Determined to be a Fault

A case in which the problem is determined to be a fault in the optical fiber is a case in which the variation (Δn_{g}) of the refractive index of the optical fiber exceeds the threshold value (Δnₜₕᵣ), and in this case, the type of fault may be determined by ascertaining the OTDR trace.

a-1) Fault Due to Cutting of Optical Fiber

In operation 950, the apparatus for improving the performance of the OTDR determines whether another peak exists between both end points of the optical fiber, besides a peak at an end of the optical fiber connected to a connector on the OTDR trace.

When another peak exists besides the peak at the end point of the optical fiber, the apparatus determines the type of fault to be a fault due to cutting of the optical fiber in operation 960, and triggers a fault alarm and recovery operation to be performed in operation 972.

In operation 970, the apparatus returns a value of the refractive index, set in the OTDR by the other peak besides the peak at the end point based on the determination result, to a value set by the initial calibration method before fault occurrence.

a-2) Fault Due to Splicing or Bending

When another peak does not exist between the both ends of the optical fiber, besides the peak at the end point of the optical fiber on the OTDR trace, the apparatus determines the type of fault to be splicing or bending of the optical fiber.

Determination of the fault to be due to splicing or bending may be performed by comparing the intensities of a Rayleigh backscattered signal with respect to two monitoring signals of different wavelengths.

That is, in a case of the fault due to splicing, the intensity (Rλ1) of the Rayleigh backscattered signal with respect to the monitoring signal of shorter wavelength is larger than the intensity (R_{λ2}) of the Rayleigh backscattered signal with respect to the monitoring signal of longer wavelength, whereas in a case of the fault due to bending, the intensity (R_{λ1}) of the Rayleigh backscattered signal with respect to the monitoring signal of shorter wavelength is smaller than the intensity (R_{λ2}) of the Rayleigh backscattered signal with respect to the monitoring signal of longer wavelength.

Accordingly, the intensities of the Rayleigh backscattered signal with respect to the two monitoring signals of different wavelengths are measured, and then the apparatus determines the type of fault to be the fault due to splicing in operation 984 when the intensity (R_{λ1}) is larger than the intensity (R_{λ2}), and as the fault due to bending in operation 986 when the intensity (R_{λ2}) is larger than the intensity (R_{λ1}).

In operation 972, the apparatus triggers a recovery operation segmented in accordance with the fault alarm and fault type, to be performed after it is determined that the fault is due to splicing or bending.

In operation 970, the apparatus returns a value (n_{g}) of the refractive index set in the OTDR to a value (n_{g}(init)) set by the initial calibration method before fault occurrence (n_{g}=(n_{g}(init))).

b) Determined to be Performance Degradation

In operation 987, when the problem is determined to be performance degradation because the amount (Δn_{g}) of change in the refractive index does not exceed the threshold value (Δnₜₕᵣ), the apparatus reflects the amount (Δn_{g}) of change in the refractive index in the value (n_{g}) of the refractive index applied to distance conversion of the OTDR.

In operation 988, the apparatus triggers a performance degradation operation to be performed for measuring a loss or the like due to the performance degradation.

According to an embodiment, in a method of distinguishing between the fault due to splicing and the fault due to bending in the real-time calibration method, two monitoring signals of different wavelengths may be used.

There are two methods of measuring the intensity of a Rayleigh backscattered signal using the two monitoring signals of different wavelengths.

A first method of using two monitoring light sources with different wavelengths, and a second method of using monitoring signals with two wavelengths by moving a monitoring light source with one wavelength using a Fiber Bragg grating (FBG) or a wavelength tunable laser may be used.

According to another embodiment, in the real-time calibration method, data about the amount of change in the refractive index of the optical fiber is accumulated to be used for statistics. The accumulated data may be used to predict performance degradation characteristics of an optical link.

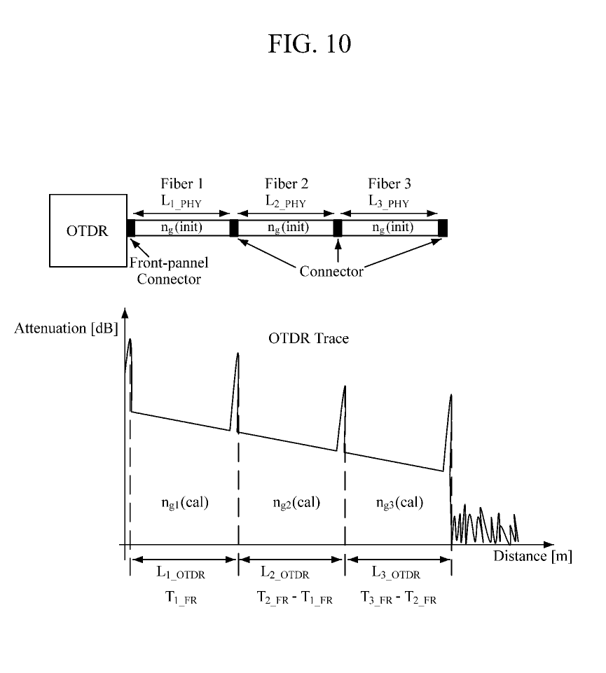

FIG. 10 is a diagram showing an OTDR trace when several optical fibers with different refractive indexes are connected.

Referring to FIG. 10, when several optical fibers with different refractive indexes are connected with each other by a connector or by splicing, refractive indexes of the optical fiber are different for every optical fiber section. For example, in FIG. 10, the refractive indexes of the optical fiber are different for each of the plurality of optical fiber sections, e.g., Fiber 1, Fiber 2, and Fiber 3 sections. Therefore, according to the present invention, initial calibration may be performed for every optical fiber section.

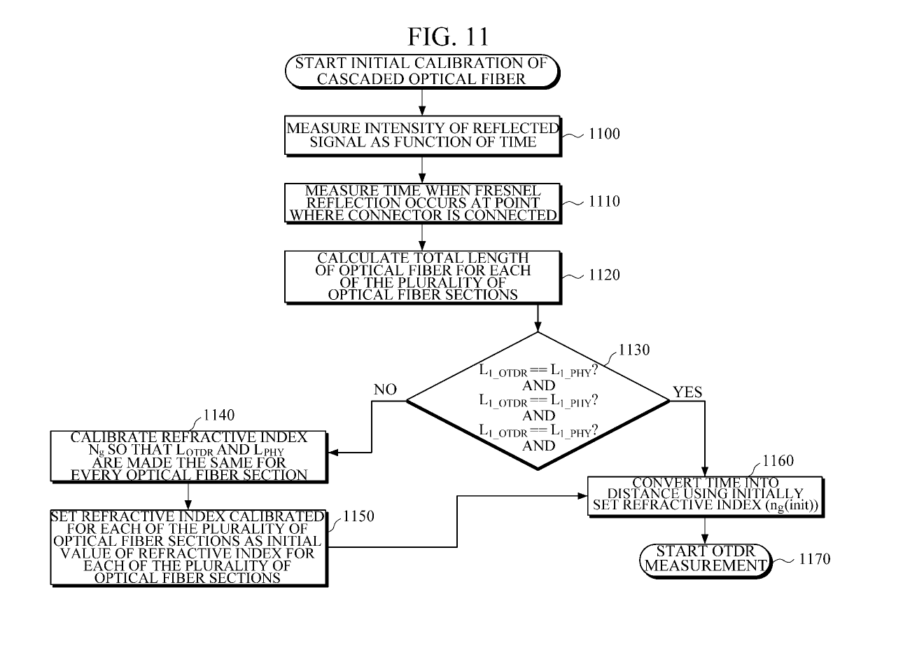

FIG. 11 is a flowchart showing a calibration method of the refractive index of an OTDR when several optical fibers with different refractive indexes are connected according to an embodiment of the present invention.

Referring to FIGS. 10 and 11, when several optical fibers with different refractive indexes are connected with each other, the apparatus for improving the performance of the OTDR calibrates the refractive index of the optical fiber for every optical fiber section.

Since the optical fibers with different refractive indexes are connected with each other by a connector for every optical fiber section, a length for every optical fiber section may be obtained.

First, in operation 1100, the apparatus measures the intensity of a reflected signal as a function of time through an OTDR.

In operation 1110, the apparatus measures times T1_FR, T2_FR, and T3_FR when Fresnel reflection occurs at a point where a connector is connected for every optical fiber section.

In operation 1120, the apparatus calculates lengths L1_OTDR, L2_OTDR, and L3_OTDR for each of the plurality of optical fiber sections of the optical fiber using Equations 7.

$${L}_{1 \_OTDR} = \frac{c}{{n}_{g} ( init )} \times {T}_{1 \text{-} FR} \\ {L}_{2 \_OTDR} = \frac{c}{{n}_{g} ( init )} \times ( {T}_{2 \text{-} FR} - {T}_{1 \text{-} FR} ) \\ {L}_{3 \_OTDR} = \frac{c}{{n}_{g} ( init )} \times ( {T}_{3 \text{-} FR} - {T}_{2 \text{-} FR} ) \qquad ( 7 )$$

Next, in operation 1130, the apparatus determines whether there are any optical fiber sections for which the length measured using the OTDR and a physically measured length are different.

In operation 1140, when there is an optical fiber section for which the two lengths are different, the apparatus calibrates only the refractive index of that section from the initially set refractive index of the optical fiber using Equations 8, so that the two lengths are made the same for every optical fiber section.

$${n}_{g 1} ( cal ) = \frac{c}{{L}_{1 PHY}} \times {T}_{1 \_FR} \\ {n}_{g 2} ( cal ) = \frac{c}{{L}_{2 PHY}} \times {T}_{2 \_FR} \\ {n}_{g 3} ( cal ) = \frac{c}{{L}_{3 PHY}} \times {T}_{3 \_FR} \qquad ( 8 )$$

Next, the apparatus sets the calibrated refractive index as an initial refractive index of the OTDR, as shown in Equation 9, in operation 1150, converts time into distance using the set initial refractive index in operation 1160, and then measures an OTDR trace in operation 1170.

ng1(init)=ng1(cal) or ng2(init)=ng2(cal) or ng3(init)=ng3(cal) (9)

In contrast, when there is no optical fiber section in which the two lengths are different, the apparatus converts time into distance using the initially set refractive index without calibration of the refractive index in operation 1160, and then measures the OTDR trace in operation 1170.

As described above, according to the present invention, through the initial calibration method of the refractive index of the optical fiber, it is possible to increase distance resolution of the OTDR.

In addition, through the real-time calibration method of the refractive index of the optical fiber, it is possible to accurately analyze fault position and fault causes when a fault or performance degradation occurs in the optical fiber.

Therefore, accuracy of the OTDR may be increased, thereby increasing efficiency of network management and further reducing costs for fault diagnosis and recovery.

While example embodiments of the present invention and their advantages have been described in detail, it should be understood that various changes, substitutions, and alterations may be made herein without departing from the scope of the invention.

What is claimed is:

1. A method of improving the performance of an optical time domain reflectometer (OTDR), comprising:
measuring a time when Fresnel reflection occurs in an optical fiber, using the OTDR;
calculating a total length of the optical fiber using the measured time when Fresnel reflection occurs and an initial value of the refractive index of the optical fiber; and
comparing the calculated total length of the optical fiber and a physically measured total length of the optical fiber, calibrating the refractive index of the optical fiber so as to match the calculated total length with the physically measured total length when the calculated total length and the physically measured total length do not match, and setting the calibrated refractive index of the optical fiber as the initial value of the refractive index.

2. The method of claim 1, wherein the measuring of the time when Fresnel reflection occurs includes measuring the time when Fresnel reflection occurs in a connector part of an end of the optical fiber.

3. The method of claim 1, wherein the setting of the calibrated refractive index includes acquiring a calibration value of the refractive index of the optical fiber using the time when Fresnel reflection occurs and the physically measured total length of the optical fiber.

4. The method of claim 1, further comprising:
acquiring an OTDR trace by converting reflected signal intensity measured as a function of time through the OTDR into a function of distance using the set initial value of the refractive index.

5. A method of improving the performance of an OTDR, comprising:
measuring a time when Fresnel reflection occurs in an optical fiber, using the OTDR;
calculating a total length of the optical fiber using the measured time when Fresnel reflection occurs and an initial value of the refractive index of the optical fiber;
calculating an amount of change in the refractive index of the optical fiber with respect to a distance from the calculated total length of the optical fiber; and
comparing the calculated amount of change in the refractive index and a threshold value to determine a type of a fault in the optical fiber based on the comparison result.

6. The method of claim 5, wherein the calculating of the amount of change in the refractive index includes calculating the amount of change in the refractive index using a difference value between a physically measured total length of the optical fiber and the calculated total length of the optical fiber, and the measured time when Fresnel reflection occurs.

7. The method of claim 5, wherein the comparing of the calculated amount of change in the refractive index includes:
comparing the calculated amount of change in the refractive index and the threshold value, and
ascertaining whether a there is a peak in an OTDR trace between both ends of the optical fiber when the calculated amount of change is larger than the threshold value, and determining the type of fault in the optical fiber to be a fault due to cutting of the optical fiber when there is a peak, and to be a fault due to a splicing point or bending of the optical fiber when there is no peak.

8. The method of claim 7, wherein the ascertaining of whether there is a peak includes:
measuring intensity of a backscattered signal with respect to monitoring signals of two wavelengths when there is no peak,
determining the type of fault in the optical fiber as a fault due to a splicing point of the optical fiber when the intensity of the backscattered signal with respect to a monitored signal of shorter wavelength, between the monitoring signals of two wavelengths, is larger than the intensity of the backscattered signal with respect to the monitoring signal of longer wavelength, and
determining the type of fault in the optical fiber as a fault due to the bending of the optical fiber when the intensity of the backscattered signal with respect to the monitoring signal of shorter wavelength is smaller than the intensity of the backscattered signal with respect to the monitoring signal of longer wavelength.

9. The method of claim 8, wherein the monitoring signals of two wavelengths are signals with different wavelengths from each other generated by different light sources.

10. The method of claim 8, wherein the monitoring signals of two wavelengths include a signal generated from a predetermined light source and having a first wavelength, and a signal having a second wavelength generated by varying the first wavelength of the signal generated from the predetermined light source.

11. The method of claim 5, further comprising:
returning the refractive index of the optical fiber to an initially set refractive index; and
performing fault recovery in accordance with fault alarm and fault type.

12. The method of claim 5, further comprising:
compiling the calculated amount of change in the refractive index of the optical fiber into a database to use the amount of change in the refractive index as statistical information.

13. A method of improving the performance of an OTDR, comprising:
measuring a time when Fresnel reflection occurs at a point where a connector is connected between each of a plurality of optical fiber sections through the OTDR;
calculating a length of an optical fiber for each of the plurality of optical fiber sections using the measured time when Fresnel reflection occurs and an initial value of the refractive index of the optical fiber; and
comparing the calculated length of the optical fiber for each of the plurality of optical fiber sections and a physically measured length of the optical fiber for each of the plurality of optical fiber sections, calibrating the refractive index of the optical fiber for each of the plurality of optical fiber sections so as to match the calculated length of the optical fiber and the physically measured length of the optical fiber when the calculated length of the optical fiber and the physically measured length of the optical fiber do not match, and setting the calibrated refractive index of the optical fiber as the initial value of the refractive index of the optical fiber for each of the plurality of optical fiber sections.

14. The method of claim 13, wherein the setting of the calibrated refractive index as the initial value of the refractive index includes acquiring a calibration value of the refractive index of the optical fiber for each of the plurality of optical fiber sections, using the time when Fresnel reflection occurs for each of the plurality of optical fiber sections and the physically measured length of the optical fiber for each of the plurality of optical fiber sections.

15. The method of claim 13, further comprising:
acquiring an OTDR trace for each of the plurality of optical fiber sections by converting reflected signal intensity measured as a function of time into a function of distance using the set initial value of the refractive index for each of the plurality of optical fiber sections.
